(19) United States
(12) Patent Application Publication
(10) Pub. No.: US 2022/0024027 A1
(43) Pub. Date: Jan. 27, 2022

(54) ROBOT FIXTURE FOR MOUNTING A ROBOT MANIPULATOR ON A TABLETOP

(71) Applicant: FRANKA EMIKA GMBH, München (DE)

(72) Inventors: Tobias Ende, München (DE); Martin Kulzer, München (DE)

(21) Appl. No.: 17/414,240

(22) PCT Filed: Dec. 19, 2019
(86) PCT No.: PCT/EP2019/086266

§ 371 Date: Jun. 15, 2021

(30) Foreign Application Priority Data
Dec. 21, 2018 (DE) 10 2018 133 417.6

(51) Int. Cl. B25J 9/00; F16B 2/12

(52) U.S. Cl. CPC B25J 9/0009; F16B 2/12

(57) ABSTRACT

A robot fixture to secure a robot manipulator to a tabletop, including a base unit having an interface to secure the robot manipulator on the base unit, wherein the base unit introduces, over a surface, a weight force of the robot manipulator to an upper face of the tabletop, wherein a first end of a clamping arm is arranged on an end face of the base unit and the clamping arm has a first portion leading away from the base unit and a second portion extending parallel to the base unit, such that, when mounting the base unit on the tabletop, the second portion extends under the tabletop, and a clamping slide, which is movable relative to the clamping arm in the direction of the base unit, is arranged on a second end of the clamping arm, and, on an end of the clamping slide facing the base unit, a cushion is arranged on the clamping slide, wherein the cushion is mounted about at least one axis in a torque-free manner relative to the clamping slide and wherein the cushion presses the robot fixture against a lower face of the tabletop.

### CROSS-REFERENCE TO RELATED APPLICATIONS

The present application is the U.S. National Phase of PCT/EP2019/086266, filed on Dec. 19, 2019, which claims priority to German Patent Application No. 10 2018 133 417.6, filed on Dec. 21, 2018, the entire contents of which are incorporated herein by reference.

### BACKGROUND

### Field

The invention relates to a robot fixture for securing a robot manipulator to a tabletop and to a method for mounting a robot manipulator on a tabletop by means of a robot fixture of the same type.

### SUMMARY

The object of the invention is to arrange the mounting of a robot manipulator on a tabletop to be gentler on the tabletop and to be simpler.

The invention results from the features of the independent claims. Advantageous refinements and embodiments are the subject matter of the dependent claims.

A first aspect of the invention relates to a robot fixture for securing a robot manipulator to a tabletop, having a base mounting unit having a robot manipulator interface for securing the robot manipulator on the base mounting unit, wherein the base mounting unit introduces, over a surface, a weight force of the robot manipulator to an upper face of the tabletop, wherein a first end of a clamping arm is arranged on an end face of the base mounting unit and the clamping arm has an arm portion leading away from the base mounting unit and an arm portion extending parallel to the base mounting unit, such that when the base mounting unit is mounted on the tabletop, the arm portion extending parallel to the base mounting unit extends under the tabletop, and wherein a clamping slide, which is movable relative to the clamping arm in the direction of the base mounting unit is arranged on a second end of the clamping arm, and, on an end of the clamping slide facing the base mounting unit, a support cushion is arranged on the clamping slide, wherein the support cushion is mounted about at least one axis in a torque-free manner relative to the clamping slide, and wherein the support cushion presses the robot fixture against a lower face of the tabletop.

The base mounting unit is preferably designed in the form of a plate, in particular as a multiplex wooden plate, a metal plate or as a plastic plate. The front face of the wooden plate is, in particular, that which is arranged in the area of the table edge of the tabletop in the assembled state of the robot fixture. This front face is also, in particular, an edge of the base mounting unit, wherein the edge is, in particular, perpendicular to the upper side and underside of the base mounting unit and has a relatively small area compared to the surfaces of the upper side and underside of the base mounting unit.

The arm portion of the clamping arm leading away from the base mounting unit therefore primarily serves, in particular, to space the arm portion of the clamping arm extending parallel to the base mounting unit away from the base mounting unit, so that a tabletop may be inserted between the base mounting unit and the arm portion of the clamping arm extending parallel to the base mounting unit.

The arm portion leading away from the base mounting unit preferably has a section extending at right angles to the upper side and/or underside of the base mounting unit, while the arm portion extending parallel to the base mounting unit preferably extends continuously under the underside of the base mounting unit. A length of the parallel extending arm portion and a length of the base mounting unit along its upper side (optionally underside) are preferably the same.

Furthermore, it is also possible for the arm portion leading away from the base mounting unit and the arm portion of the clamping arm extending parallel to the base mounting unit to have any shape in the respective extension direction of the clamping arm thus defined—the clamping arm may, in particular, be angled, arcuate or elliptical.

The clamping slide is advantageously arranged and movable relative to the base mounting unit in such a way that when the clamping slide is moved towards the base mounting unit without a tabletop being located between the support cushion and the base mounting unit, the support cushion is also pressed against the base mounting unit. If, on the other hand, the robot fixture is already arranged on the tabletop in such a way that the base mounting unit is on the upper face of the tabletop, ultimately hits the lower face of the tabletop when the clamping slide is moved onto the base mounting unit.

The support cushion has a preferably hemispherical or disk-shaped design.

It is an advantageous effect of the invention that by means of the support cushion, which is mounted about at least one axis in a torque-free manner relative to the clamping slide, the orientation of the support cushion automatically adapts to the surface of the lower face of the tabletop for optimal pressure distribution when the support cushion is pressed against an lower face of the tabletop. The robot fixture further allows a robot manipulator to be mounted quickly and easily on a tabletop.

According to one advantageous embodiment, exactly two clamping arms are arranged on the base mounting unit.

According to this embodiment, the first end of a first clamping arm and the first end of a second clamping arm are arranged on the end face of the base mounting unit. Accordingly, preferably exactly two, preferably structurally identical clamping arms are arranged on the end face of the base mounting unit. This advantageously prevents or slows down a self-loosening of the respective support cushion, in particular, when the clamping slide is a threaded spindle by means of which the respective support cushion is pressed against the lower face of the tabletop by turning the threaded spindle.

According to a further advantageous embodiment, the clamping slide is a threaded spindle, wherein the threaded spindle is guided through an internal thread arranged in the clamping arm. The threaded spindle is, in particular, a rod with an external thread, wherein the external thread is guided in the internal thread of the clamping arm so that turning the threaded spindle causes a translational displacement of the threaded spindle in its axial direction towards the base mounting unit or away from the base mounting unit—depending on the direction of rotation of the threaded spindle.

According to a further advantageous embodiment, the threaded spindle has a tool interface on the side facing away from the support cushion for attaching a tool for rotating the threaded spindle.

The tool advantageously includes a torque adapter for setting a maximum allowable tightening torque for the threaded spindle. This advantageously enables a force of the support cushion against the tabletop, which is sufficiently strong, but does not damage the tabletop.

According to a further advantageous embodiment, the tool interface has a hexagon socket profile.

According to a further advantageous embodiment, a nut is arranged on the threaded spindle.

The nut is preferably a self-locking nut. A self-loosening of the respective support cushion from the lower face of the tabletop is advantageously prevented by independently unscrewing the threaded spindle.

According to a further advantageous embodiment, the support cushion and the clamping slide are connected via a ball joint.

The ball joint advantageously allows a torque-free mounting about two mutually perpendicular axes, wherein these axes themselves are in turn perpendicular to the direction of displacement of the clamping slide. As a result, the orientation of the support cushion advantageously adapts to the surface of the lower face of the tabletop when it is pressed against the lower face of the tabletop.

According to a further advantageous embodiment, the clamping slide is mounted rotatably with respect to the clamping arm.

A clamping slide rotatable with respect to the clamping arm advantageously allows the robot fixture to be easily arranged even on a table with a strongly protruding table edge. The clamping arm is able to be guided past the edge of the table by turning the clamping slide so that the support cushion is at a much greater distance from the base mounting unit. After passing by, the clamping slide is able to then be rotated back into its normal position in order to move the clamping slide so that it presses the support cushion against the base mounting unit.

The clamping slide is preferably rotatable by 90° with respect to the clamping arm.

The clamping slide is preferably rotatable in a directed manner away from the clamping arm, in particular away from the arm portion of the clamping arm leading away from the base mounting unit.

According to a further advantageous embodiment, the clamping slide is rotatable via locking positions.

The locking positions advantageously allow the clamping slide to be rotated back into an orientation at right angles to the base mounting unit.

According to a further advantageous embodiment, the support cushion has elastomeric plastic on its surface facing the lower face of the tabletop.

The elastomeric plastic advantageously increases the adhesive friction between the support cushion and the lower face of the tabletop.

Another aspect of the invention relates to a method for mounting a robot manipulator on a tabletop by means of a robot fixture, wherein the robot fixture has a base mounting unit having a robot manipulator interface and wherein the base mounting unit introduces, over a surface, the weight of the robot manipulator to an upper face of the tabletop, wherein a first end of a clamping arm is arranged on an end face of the base mounting unit, and the clamping arm has an arm portion leading away from the base mounting unit and an arm portion extending parallel to the base mounting unit, and wherein a clamping slide, which is movable relative to the clamping arm in the direction of the base mounting unit, is arranged on a second end of the clamping arm, and, on a second end of the clamping slide facing the base mounting unit, a support cushion is arranged on the clamping slide about at least one axis in a torque-free manner, the method including:
arranging the base mounting unit on the upper face of the tabletop while at the same time guiding the arm portion extending parallel to the base mounting unit under the tabletop;
moving the clamping slide in the direction of the base mounting unit to press the support cushion against a lower face of the tabletop; and
securing the robot manipulator to the robot manipulator interface of the base mounting unit.

According to one advantageous embodiment of the method—wherein the clamping slide is a threaded spindle and the threaded spindle is guided through an internal thread arranged in the clamping arm, and wherein the threaded spindle has a tool interface facing away from the support cushion for attaching a tool to rotate the threaded spindle—the motion of the clamping slide takes place in the direction of the base mounting unit to press the support cushion against the lower face of the tabletop by means of a torque wrench up to a predetermined maximum torque.

Advantages and preferred refinements of the proposed method result from an analogous and corresponding application of the statements made above in connection with the proposed device.

Further advantages, features and details result from the following description, in which—if necessary with reference to the drawings—at least one example embodiment is described in detail. Identical, similar and/or functionally identical parts are provided with the same reference numerals.

### BRIEF DESCRIPTION OF THE DRAWINGS

In the drawings:

FIG. 1 shows a robot fixture for securing a robot manipulator to a tabletop according to one example embodiment of the invention; and

FIG. 2 shows a method for mounting a robot manipulator on a tabletop by means of a robot fixture according to a further example embodiment of the invention.

The representations in the drawings are schematic and not to scale.

### DETAILED DESCRIPTION

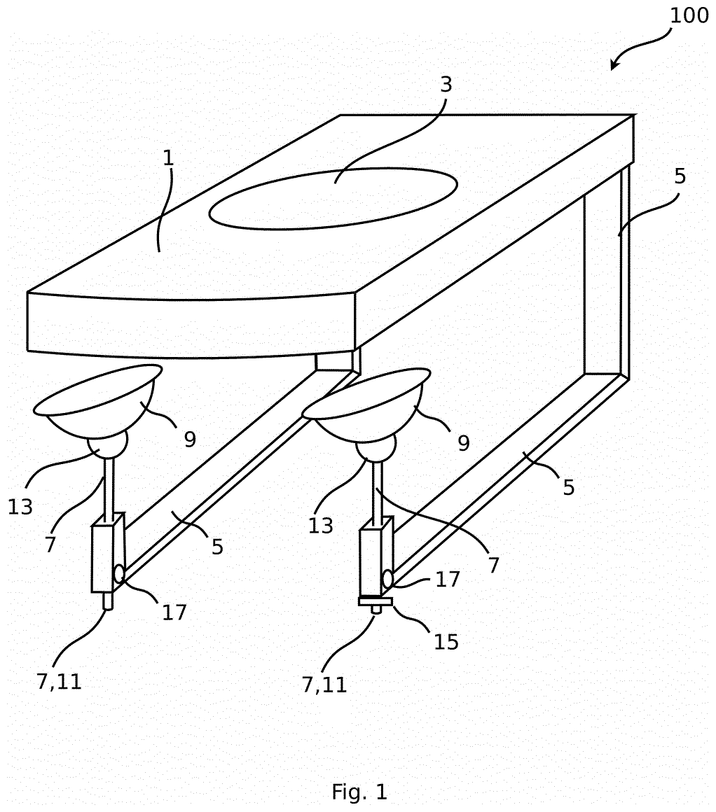

FIG. 1 shows a robot fixture 100 for securing a robot manipulator to a tabletop. The robot fixture 100 has a base mounting unit 1 made from a wooden panel with a robot manipulator interface 3. The robot manipulator interface 3 has corresponding screw connection elements for securing the robot manipulator on the base mounting unit 1. The base mounting unit 1 serves, in principle, to introduce, over a surface, a weight force of the robot manipulator to an upper face of the tabletop on which the robot manipulator is to be arranged. A respective first end of two clamping arms 5—the rear edge of the plate-like base mounting unit 1 not visible in FIG. 1—is arranged on an end face of the base mounting unit 1. The clamping arms 5 are spaced apart from one another and are each arranged under and along a side surface adjoining the front end of the base mounting unit 1. The respective clamping arm 5 has an arm portion leading away from the base mounting unit 1 and connected thereto an arm portion following a bend extending at a right angle in each case parallel to the base mounting unit 1, so that when the base mounting unit 1 is mounted on the tabletop, the arm portion extending parallel to the base mounting unit 1 extends under the tabletop. Arranged on a second end of each clamping arm 5 is a respective clamping slide 7 movable relative to the respective clamping arm 5 in the direction of the base mounting unit 1. The respective clamping slide 7 of the respective clamping arm 5 is designed as a threaded spindle, which by turning relative to the respective clamping arm 5, in which a matching internal thread is arranged, is moved in a translatory manner in the direction of, or away from, the base mounting unit 1—depending on the direction of rotation. A support cushion 9 is arranged on the clamping slide 7 at one end of the respective clamping slide 7 facing the base mounting unit 1. This respective support cushion 9 is mounted by means of a ball joint 13 in a predetermined angular range in a torque-free manner with respect to the respective clamping slide 7, the support cushion 9 pressing the robot fixture 100 against a lower face of the tabletop. The respective threaded spindle 7 has, on the side facing away from the support cushion 9, a tool interface 11 for attaching a tool for rotating the threaded spindle. This tool interface 11 is equipped with a hexagon socket profile in order to enable the threaded spindle 7 to be rotated with a hexagon tool having a torque adapter. A nut 15 is arranged, for example, on the threaded spindle 7 of the clamping arm 5 shown on the right in FIG. 1. The respective clamping slide 7 is rotatably mounted with respect to the respective clamping arm 5 by means of a respective swivel joint 17.

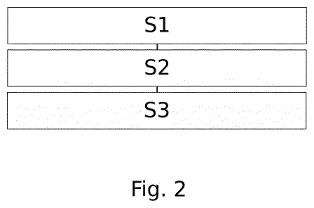

FIG. 2 shows a method for mounting a robot manipulator on a tabletop by means of a robot fixture 100, the robot fixture 100 having a base mounting unit 1 having a robot manipulator interface 3 and wherein the base mounting unit 1 introduces, over a surface, the weight of the robot manipulator to an upper face of the tabletop, wherein a first end of a clamping arm 5 is arranged on an end face of the base mounting unit 1 and the clamping arm 5 has an arm portion leading away from the base mounting unit 1 and an arm portion extending parallel to the base mounting unit 1, and wherein on a second end of the clamping arm 5 a clamping slide 7, which is movable relative to the clamping arm 5 in the direction of the base mounting unit 1, is arranged and, at an end of the clamping slide 7 facing the base mounting unit 1, a support cushion 9 is arranged on the clamping slide 7 about at least one axis in a torque-free manner, wherein the clamping slide 7 is a threaded spindle and the threaded spindle is guided through an internal thread arranged in the clamping arm 5, wherein the threaded spindle has a tool interface 11 on the side facing away from the support cushion 9 for attaching a tool for rotating the threaded spindle, the method including:
arranging S1 the base mounting unit 1 on the upper face of the tabletop while at the same time guiding the arm portion extending parallel to the base mounting unit 1 under the tabletop;
moving S2 the clamping slide 7 in the direction of the base mounting unit 1 to press the support cushion 9 against a lower face of the tabletop by turning the clamping slide 7 by means of a torque wrench up to a predetermined maximum torque; and
securing S3 the robot manipulator to the robot manipulator interface 3 of the base mounting unit 1.

Although the invention has been illustrated and explained in greater detail by means of preferred example embodiments, the invention is not limited by the disclosed examples and other variations may be derived therefrom by a person skilled in the art without departing from the scope of protection of the invention. It is therefore clear that a plurality of possible variations exists. It is also clear that embodiments cited by way of example actually only constitute examples that are not to be interpreted in any way as a limitation, for example, of the scope of the potential applications, or of the configuration of the invention. Rather, the preceding description and the description of the figures enable the person skilled in the art to specifically implement the example embodiments, wherein the person skilled in the art having knowledge of the disclosed inventive concept is able to make numerous changes, for example, with respect to the function or the arrangement of individual elements cited in an example embodiment, without departing from the scope of protection, which is defined by the claims and their legal equivalents such as, for example, further explanations in the description.

### LIST OF REFERENCE NUMERALS

1 Base mounting unit
3 Robot manipulator interface
5 Clamping arm
7 Clamping slide
9 Support cushion
11 Tool interface
13 Ball joint
15 Nut
17 Swivel joint
100 Robot fixture
S1 Arrange
S2 Move
S3 Secure

1. A robot fixture to secure a robot manipulator to a tabletop, comprising a base mounting unit having a robot manipulator interface for securing the robot manipulator on the base mounting unit, wherein the base mounting unit introduces, over a surface, a weight force of the robot manipulator to an upper face of the tabletop, wherein a first end of a clamping arm is arranged on an end face of the base mounting unit and the clamping arm has a first arm portion leading away from the base mounting unit and a second arm portion extending parallel to the base mounting unit, so that when mounting the base mounting unit on the tabletop, the second arm portion extends under the tabletop, and wherein a clamping slide, which is movable relative to the clamping arm in the direction of the base mounting unit, is arranged on a second end of the clamping arm, and, on an end of the clamping slide facing away from the base mounting unit, a support cushion is arranged on the clamping slide, wherein the support cushion is mounted about at least one axis in a torque-free manner relative to the clamping slide and the support cushion presses the robot fixture against a lower face of the tabletop.

2. The robot fixture according to claim 1, wherein exactly two clamping arms are arranged on the base mounting unit.

3. The robot fixture according to claim 1, wherein the clamping slide is a threaded spindle, the threaded spindle being guided through an internal thread arranged in the clamping arm.

4. The robot fixture according to claim 3, wherein the threaded spindle has a tool interface on the side facing away from the support cushion for attaching a tool for rotating the threaded spindle.

5. The robot fixture according to claim 4, wherein the tool interface has a hexagon socket profile.

6. The robot fixture according to claim 1, wherein the clamping slide is mounted rotatably relative to the clamping arm.

7. The robot fixture according to claim 6, wherein the clamping slide is rotatable via locking positions.

8. The robot fixture according to claim 1, further comprising a ball joint connecting the support cushion and the clamping slide.

9. A method of mounting a robot manipulator on a tabletop by means of a robot fixture, wherein the robot fixture has a base mounting unit having a robot manipulator interface and wherein the base mounting unit introduces, over a surface, the weight of the robot manipulator to an upper face of the tabletop, wherein a first end of a clamping arm is arranged on an end face of the base mounting unit and the clamping arm has a first arm portion leading away from the base mounting unit and a second arm portion extending parallel to the base mounting unit, and wherein a clamping slide, which is movable relative to the clamping arm in the direction of the base mounting unit, is arranged on a second end of the clamping arm, and, on an end of the clamping slide facing the base mounting unit, a support cushion is arranged about at least one axis in a torque-free manner on the clamping slide, the method comprising:
arranging the base mounting unit on the upper face of the tabletop while at the same time guiding the second arm portion under the tabletop;
moving the clamping slide in the direction of the base mounting unit to press the support cushion against a lower face of the tabletop; and
securing the robot manipulator to the robot manipulator interface of the base mounting unit.

10. The method according to claim 9, wherein the clamping slide is a threaded spindle, the method further comprising:
guiding the threaded spindle through an internal thread arranged in the clamping arm, wherein the threaded spindle has a tool interface on the side facing away from the support cushion for attaching a tool to rotate the threaded spindle; and
moving the clamping slide in the direction of the base mounting unit to press the support cushion against the lower face of the tabletop takes place by turning the clamping slide by using a torque wrench up to a predetermined maximum torque.

11. The method fixture according to claim 9, further comprising arranging exactly two clamping arms on the base mounting unit.

12. The method according to claim 10, wherein the tool interface has a hexagon socket profile.

13. The method according to claim 9, further comprising mounting the clamping slide rotatably relative to the clamping arm.

14. The method according to claim 13, wherein the clamping slide is rotatable via locking positions.

15. The method according to claim 9, further comprising connecting the support cushion and the clamping slide via a ball joint.
